(19) United States
(12) Patent Application Publication
(10) Pub. No.: US 2008/0189146 A1
(43) Pub. Date: Aug. 7, 2008

(54) Computerized System for Transporting Cargo

(76) Inventor: Houssam Salloum, Dearborn, MI (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 11/666,936

(22) PCT Filed: Nov. 2, 2005
(86) PCT No.: PCT/US05/39477

§ 371 Date: Feb. 19, 2008

Related U.S. Application Data
(60) Provisional application No. 60/624,784, filed on Nov. 3, 2004.

(51) Int. Cl. G01C 21/34

(52) U.S. Cl. 705/6

(57) ABSTRACT

A computerized system for selecting a cargo carrier includes a host computer system (20) having access to data of a cargo carrier. The host computer system (20) is accessed by a user (40) via an internet connection (30). Input means are provided for receiving information from the user (40) into the host computer system (20) concerning cargo to be transported. Output means are provided for sending information to a user (40) of possible cargo transportation options.

### CROSS-REFERENCE TO RELATED APPLICATIONS

This application claims the benefit of United States Provisional Application No. 60/624,784, filed Nov. 3, 2004, the disclosure of which is incorporated herein by reference.

### BACKGROUND OF THE INVENTION

This invention relates generally to a system of marine, air and land transportation of cargo, freight, materials, and goods. In particular, this invention is concerned with a computerized system for selecting a cargo transporter and arranging for the transportation of cargo. This system is accessible to users via an Internet web site.

Air and marine cargo carriers provide transportation services from ports of loading to ports of discharge. Land (road and rail) cargo carriers provide transportation services from distribution and other pick-up points to various delivery points. Customers or users can contact a carrier directly or through an agent to determine itineraries and prices. In order to determine which carrier provides the best match of service (type of cargo transported, price, delivery time, etc.), it may be necessary to contact several carriers. Contacting many carriers to determine a match and arrange for the transportation of cargo may be time-consuming and complex.

Historically, agents played a large role in marketing and selling space on a cargo vessel such as a ship, an aircraft, or a truck. The large number of options for global cargo transportation services requires that many factors be considered when selecting a cargo carrier. Furthermore, many market factors can significantly affect prices charged for transportation services.

### SUMMARY OF THE INVENTION

This invention includes a computerized system for transporting cargo with marine, air, and land carriers. The computerized system receives inputs from a user such as port of loading, port of discharge, and type of cargo. The system determines and displays carriers that provide service for the desired route and cargo. The system also provides information such as prices and customs requirements and enables a user to book the transportation of cargo. The system also creates a record of the desired service so that a user or an agent can use the information to finalize a transaction at a later time.

In a preferred embodiment, a computerized system for selecting a cargo carrier includes a host computer system having access to data of a cargo carrier. The host computer system is accessed by a user via an internet connection. Input means are provided for receiving information from the user into the host computer system concerning cargo to be transported. Output means are provided for sending information to a user of possible cargo transportation options.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of a computerized system for transporting cargo according to this invention.

FIG. 2 is a schematic block diagram of a host computer system illustrated as part of the system in FIG. 1.

FIG. 3 is a title or start computer screen generated by the host computer system illustrated in FIG. 2.

FIG. 4 is an example display page generated by the host computer system asking what type of cargo is to be shipped and what is the desired port of loading.

FIG. 5 is an example display page generated by the host computer system listing sample ports of loading in North America.

FIG. 6 is an example display page generated by the host computer system asking what is the desired port of discharge.

FIG. 7 is an example display page generated by the host computer system listing sample ports of discharge in Africa.

FIG. 8 is an example display page generated by the host computer system indicating a selected port of loading and a selected port of discharge.

FIG. 9 is an example display page generated by the host computer system showing available itineraries from all carriers providing the requested service between the selected port of loading and the selected port of discharge.

FIG. 10 is an example display page generated by the host computer system showing input windows for user id, password, and others.

FIG. 11 is an example display page generated by the host computer system asking for dimensional cargo information.

FIG. 12 is an example display page generated by the host computer system asking for cars, vans, and trucks cargo information.

FIG. 13 is an example display page generated by the host computer system asking for break bulk cargo information.

FIG. 14 is an example display page generated by the host computer system asking for containers cargo information.

FIG. 15 is an example display page generated by the host computer system showing available itineraries for the entered cargo.

FIG. 16 is an example display page generated by the host computer system showing payment options for the entered cargo.

FIG. 17 is an example display page generated by the host computer system related to Bill of Lading information.

FIG. 18 is a second example display page generated by the host computer system related to Bill of Lading information.

FIG. 19 is an example display page generated by the host computer system listing a vessel itinerary.

### DETAILED DESCRIPTION OF THE PREFERRED EMBODIMENT

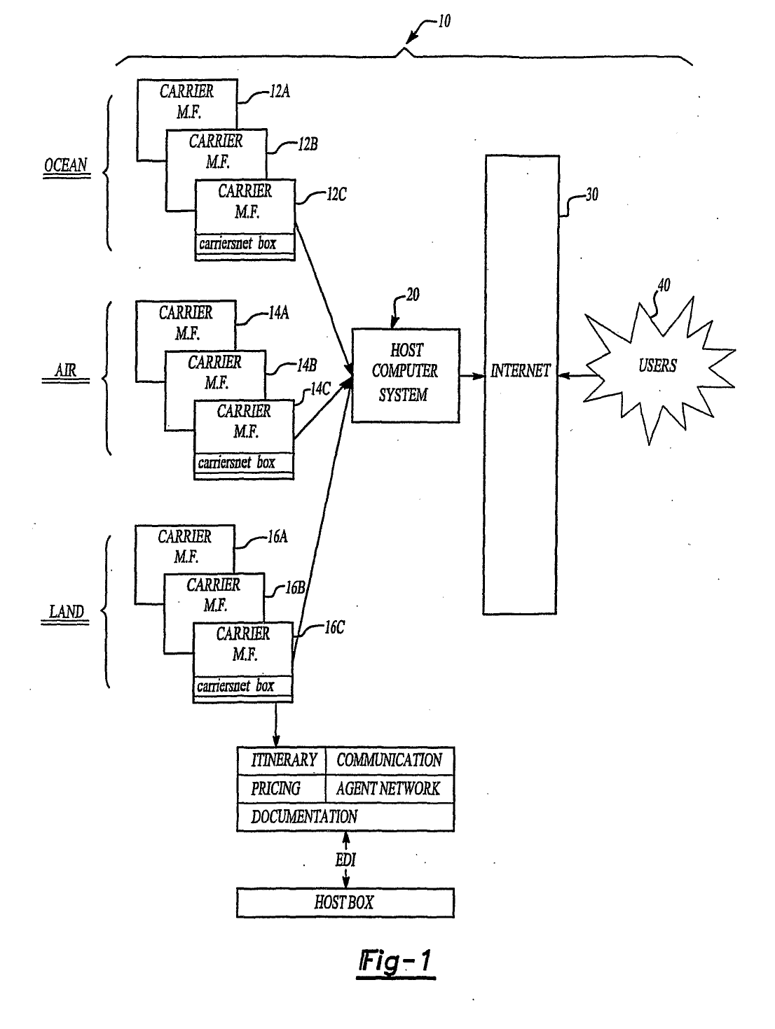

A schematic illustration of a computerized system for transporting cargo, freight, materials, and goods according to this invention is indicated generally at 10 in FIG. 1. Individual computer systems 12A, 12B, and 12C of oceanic or marine cargo carriers are preferably connected to a computer system 20 of a host computer system. Individual computer systems 14A, 14B, and 14C of air cargo carriers are preferably connected to the host computer system 20. Individual computer systems 16A, 16B, and 16C of land cargo carriers are preferably connected to the host computer system 20. The individual computer systems 12A-12C, 14A-14C, and 16A-16C contain information such as itineraries for vessels, aircraft, and vehicles, available space, price, etc. This information can be linked to the host computer system 20 by an internet connection. This information can also be transmitted to the host computer system 20 by any desired means, including an internet transfer.

The host computer system 20 is connected to the internet 30. A domain name is provided so that internet users can contact the host computer system 20. An example of a domain name for the host computer system 20 is carriersnet.com.

Users 40 who wish to transport cargo, freight, materials, or goods can access the host computer system 20 through an on-line connection via the internet 30. Upon contacting the host computer system 20, a series of questions can guide a user to the available options for transporting the cargo. For example, the prompts can start with questions such as “port of loading?” and “port of discharge?” Graphic illustrations can accompany the prompts to assist the user. For example, a graphic illustration may include a map may with various click-on portions so that a user can point-and-click to expedite and ease the task of answering the prompts.

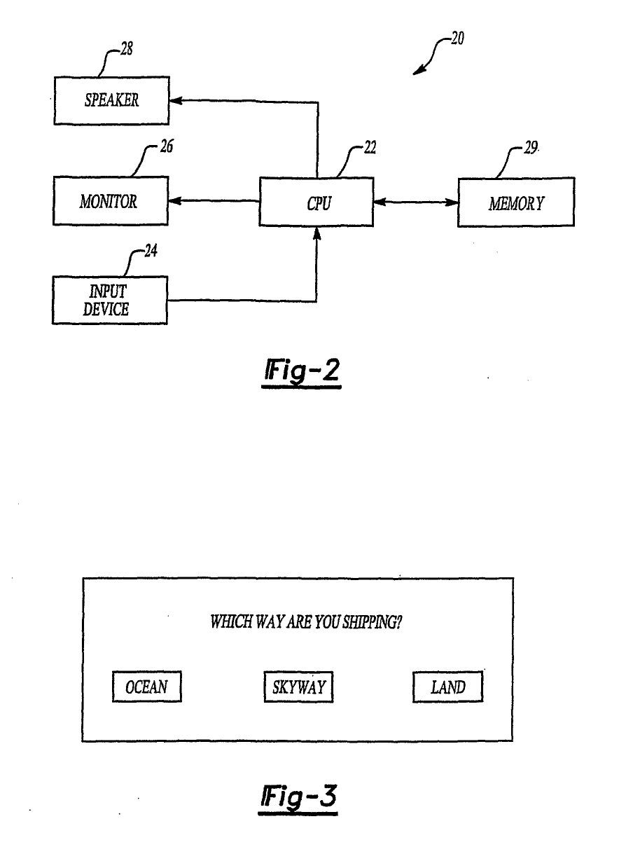

A schematic block diagram of the host computer system 20 is illustrated in FIG. 2. The host computer system 20 includes a central processing unit (CPU) 22 that includes software. An input device 24, such as a mouse, has an output connected to an input of the CPU 22. A video signal output of the CPU 22 is connected to an input of a monitor 26. The CPU 22 can include a sound card for generating an audio signal at an audio output connected to an input of a speaker 28. An input/output port of the CPU 22 is connected to an input/output port of a memory 29 that can be a hard drive for storing operating system software and an application program for performing steps according to this invention.

A system according to this invention for electronically selecting a cargo carrier and booking transportation of cargo is described below. A user 40 can access the web site of the host computing system 20 via the internet 30. Software contained in the CPU 22 can receive inputs from a user 40 and transmit responses to the user 40.

An example start screen is indicated generally at 50 in FIG. 3. The screen 50 is generated by software of the host computing system 20. The start screen can prompt a user 40 in the use of the system 10. An example of a beginning prompt is to ask a user 40 to select one of three transporting options: oceanway 51, skyway 52, and land 53. A used can point-and-click on a button for one of the options 51, 52, and 53.

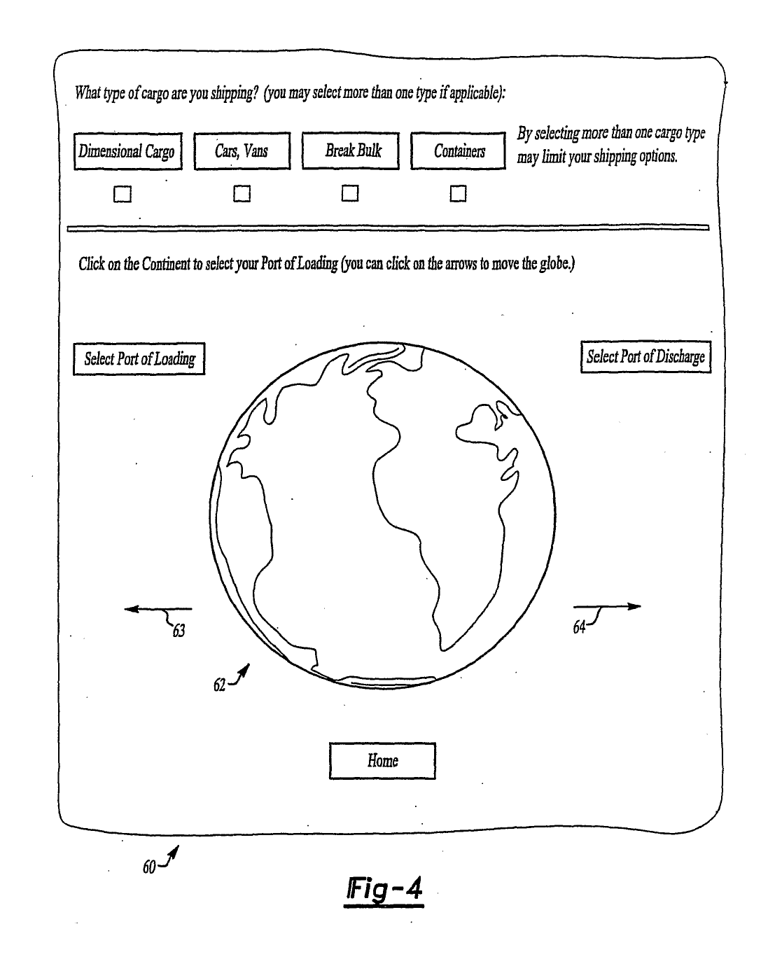

An example display page is indicated generally at 60 in FIG. 4. The page 60 can prompt a user 40 to select a port of loading option 61. The user 40 can be assisted by a global illustration 62. The global illustration 62 can be rotated by clicking on arrows 63 or 64 to show a desired part of the world.

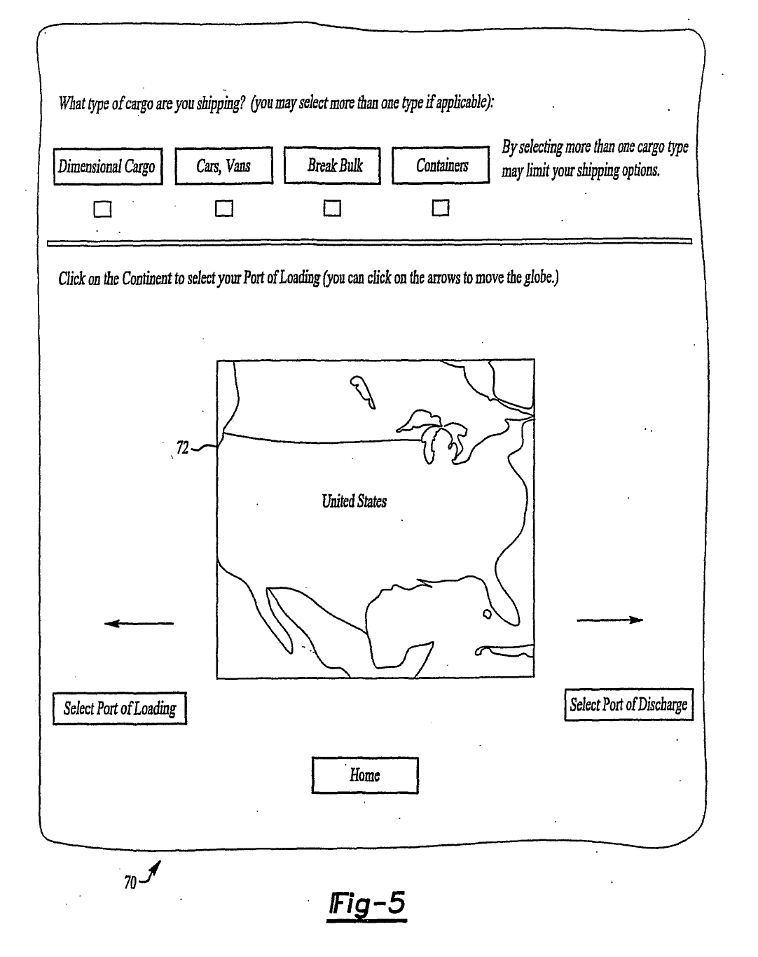

An example display page is indicated generally at 70 in FIG. 5. A map 72 can assist the user 40. The map 72 can include numerous ports of loading that can be selected by clicking.

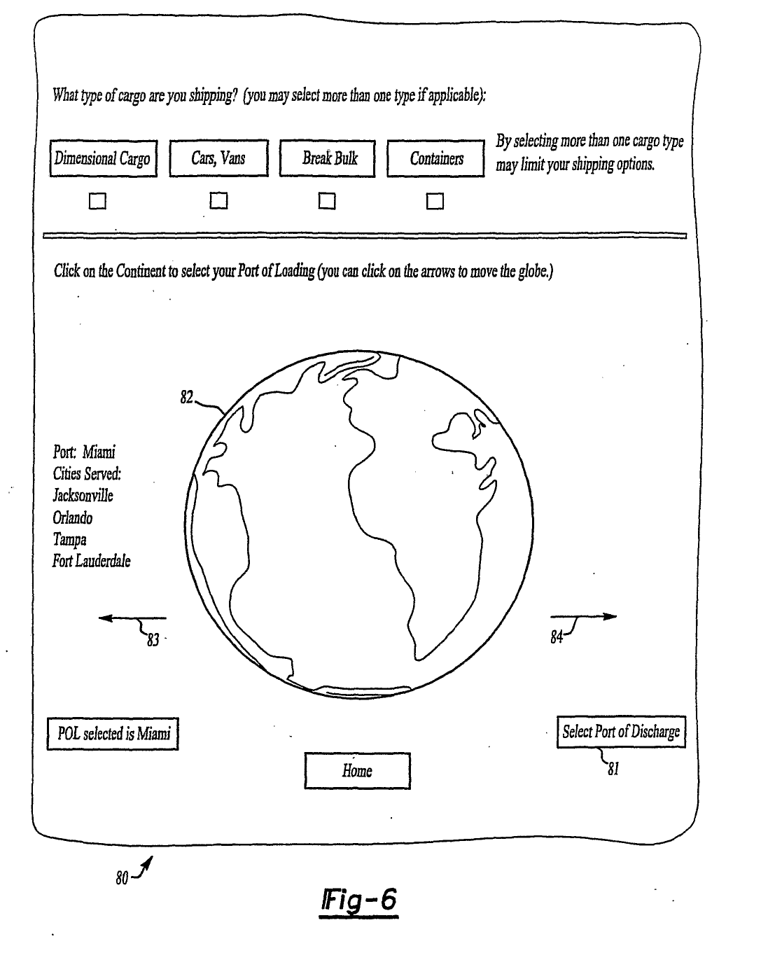

An example display page is indicated generally at 80 in FIG. 6. The page 80 can prompt a user 40 to select a port of discharge option 81. The user 40 can be assisted by a global illustration 82. The global illustration 82 can be rotated by clicking on arrows 83 or 84 to show a desired part of the world.

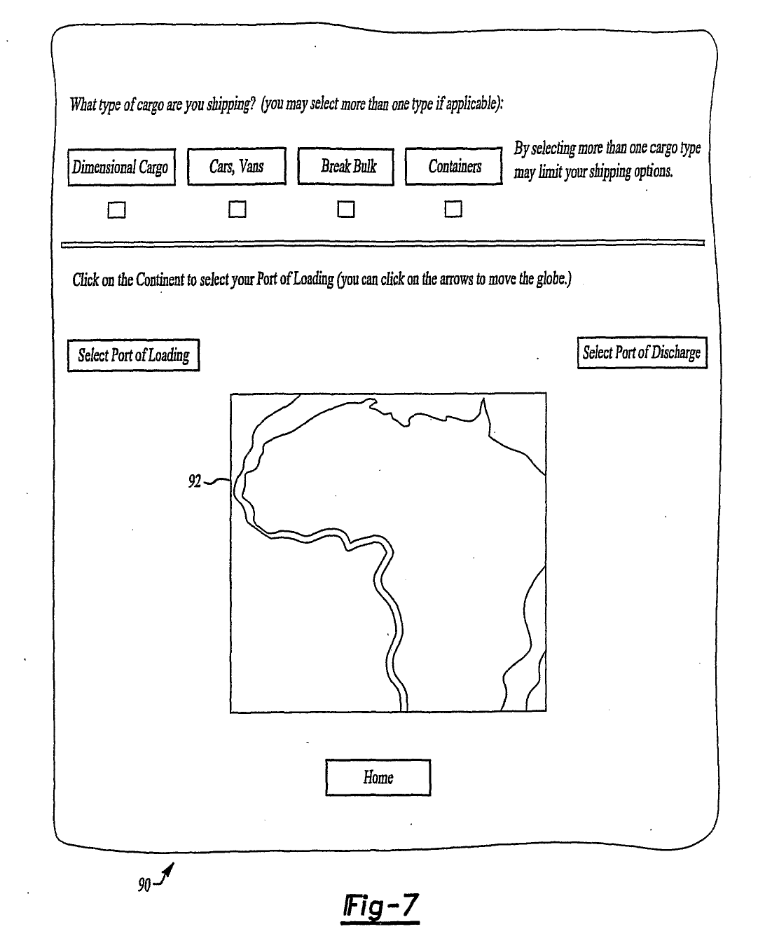

An example display page is indicated generally at 90 in FIG. 7. A map 92 can assist the user 40. The map 92 can include numerous ports of discharge that can be selected by clicking.

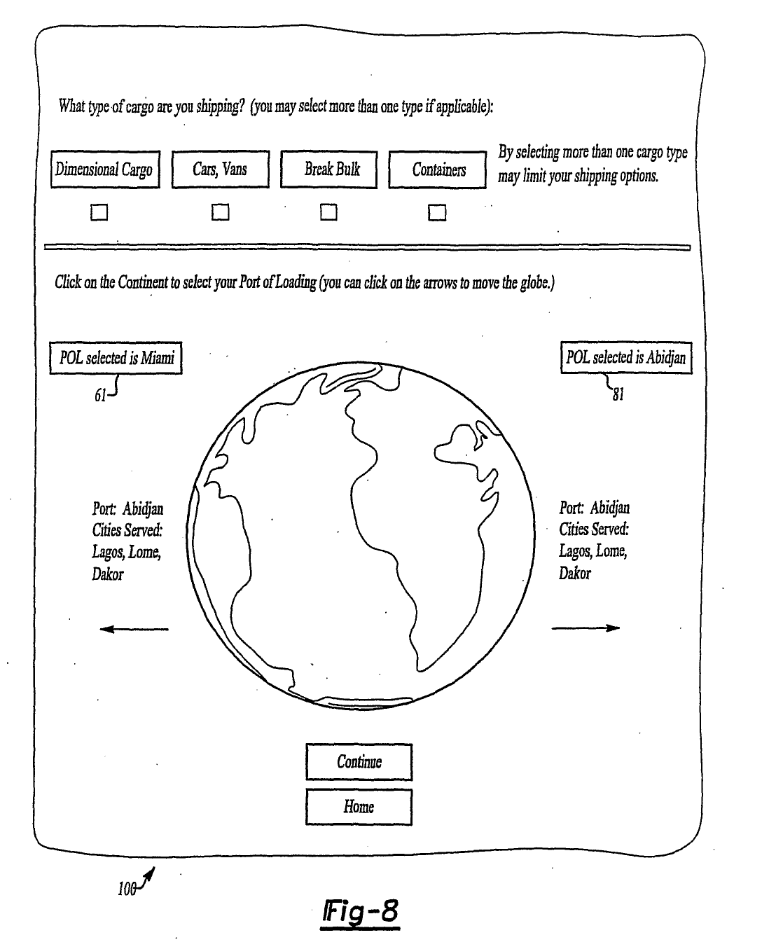

After a user has selected a port of loading 61 and a porting of discharge 81, an example display page indicated generally at 100 in FIG. 8 is generated by the host computing system 20. In the example display page 100, Miami has been selected as the port of loading 61 and Abidjan has been selected as the port of discharge 81.

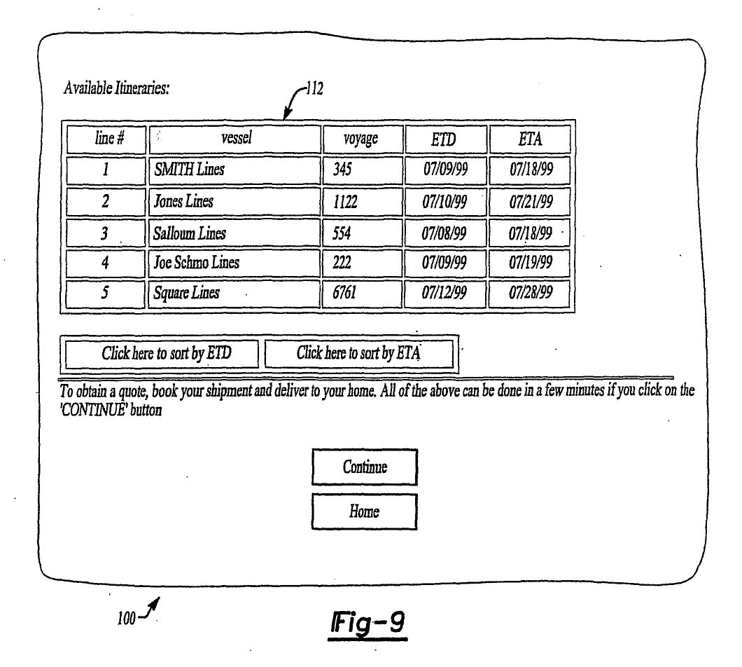

The host computer system 20 will analyze inputs from the user 40 and provide available transportation options. An example display page indicated generally at 110 in FIG. 9 lists available itineraries 112. Example of itinerary information includes vessel, voyage, Estimated Time of Departure, and Estimated Time of Arrival.

The host computer system 20 can also provide a quote, book cargo, and insurance, customs, and bill of lading (B/L) information. The host computer system 20 can also provide the client 40 with information regarding agents based on inputs received from the client 40. Input collected by the host computer system 20 can be forwarded to an agent for use in assisting the client 40.

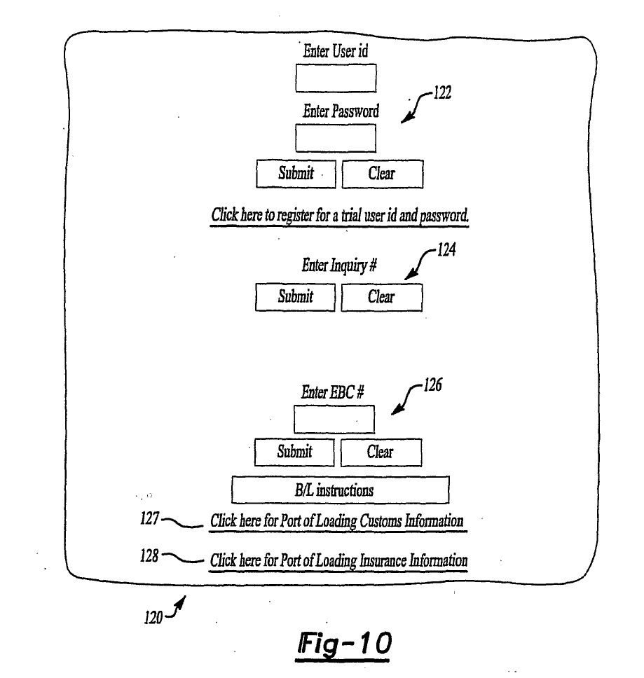

The host computer system 20 can be set up with a user id and password system 122 as illustrated in the example display page 120 of FIG. 10. An inquiry number 124 and an electronic booking confirmation 126 can be created by the host computer system 20. A user 40 can enter this information at page 120 to access the host computer system 20. Port of loading customs information 127 and port of loading insurance information 128 can be provided to the user 40.

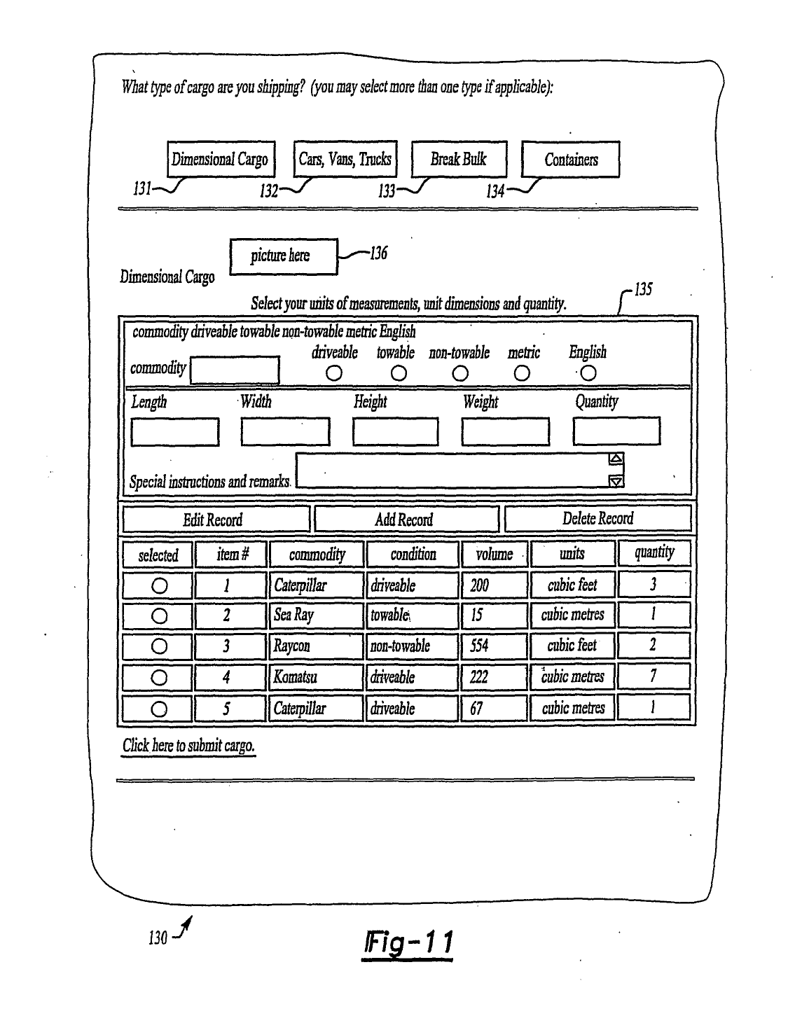

An example display page is indicated generally at 130 in FIG. 11. The page 130 can prompt a user 40 to what type of cargo is to be shipped. For example, four options can be presented: dimensional cargo 131, cars, vans, trucks 132, break bulk 133, and containers 134. When the dimensional cargo option 131 is selected, the user 40 is prompted to enter measurements and dimensional information in box 135. The user 40 can be assisted with illustrations by clicking on window 136.

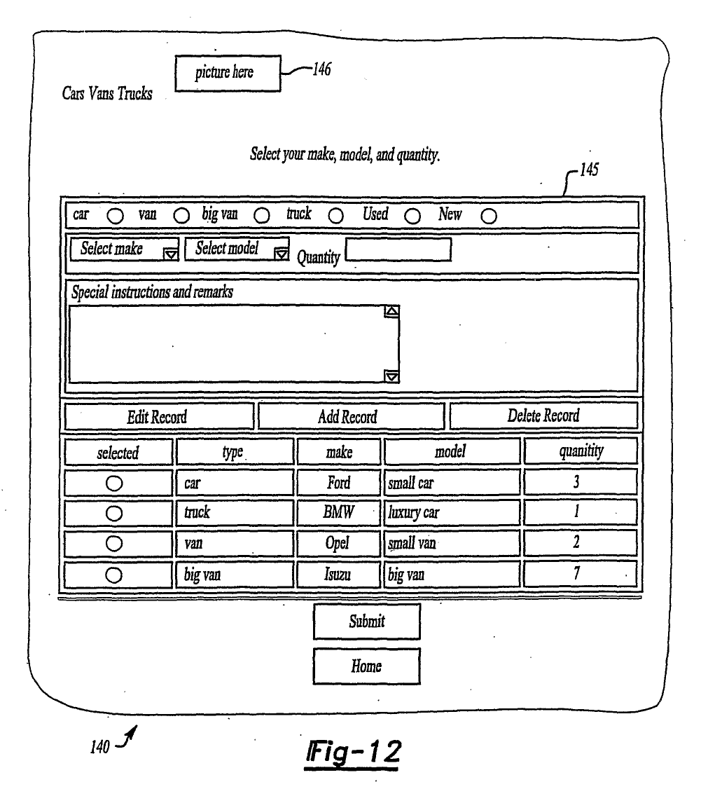

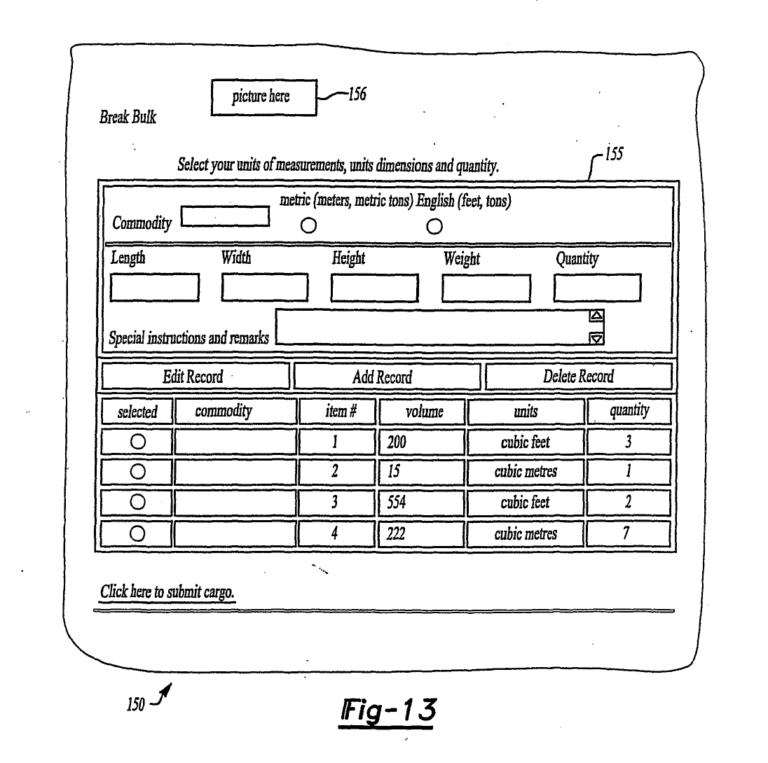

When the cars, vans, truck option 132 is selected, an example display page 140 illustrated in FIG. 12 is generated by the host computer system 20. The user 40 is prompted to enter vehicular information in box 145. The user 40 can be assisted with illustrations by clicking on window 146.

When the break bulk option 133 is selected, an example display page 150 illustrated in FIG. 13 is generated by the host computer system 20. The user 40 is prompted to enter vehicular information in box 155. The user 40 can be assisted with illustrations by clicking on window 156.

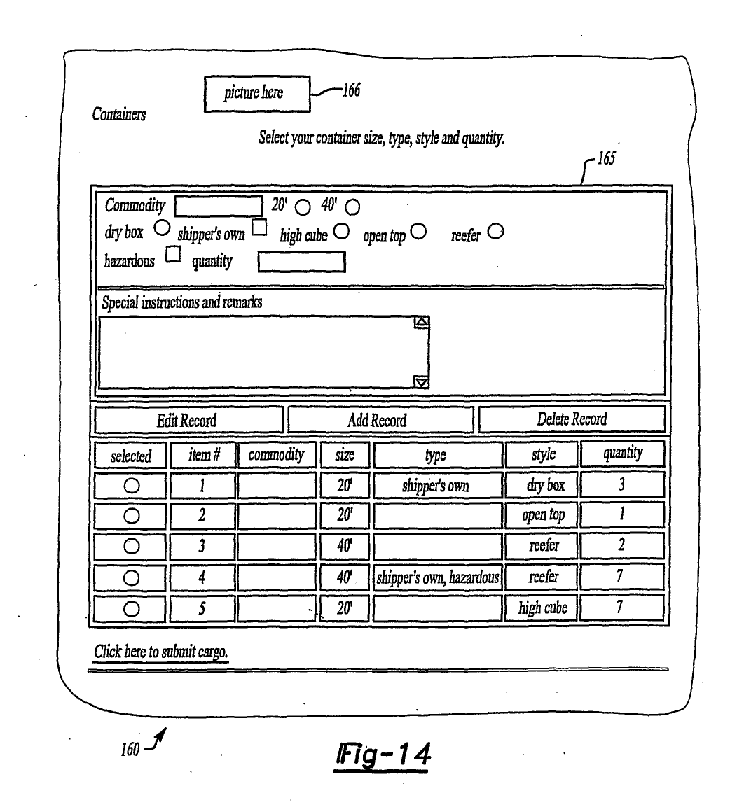

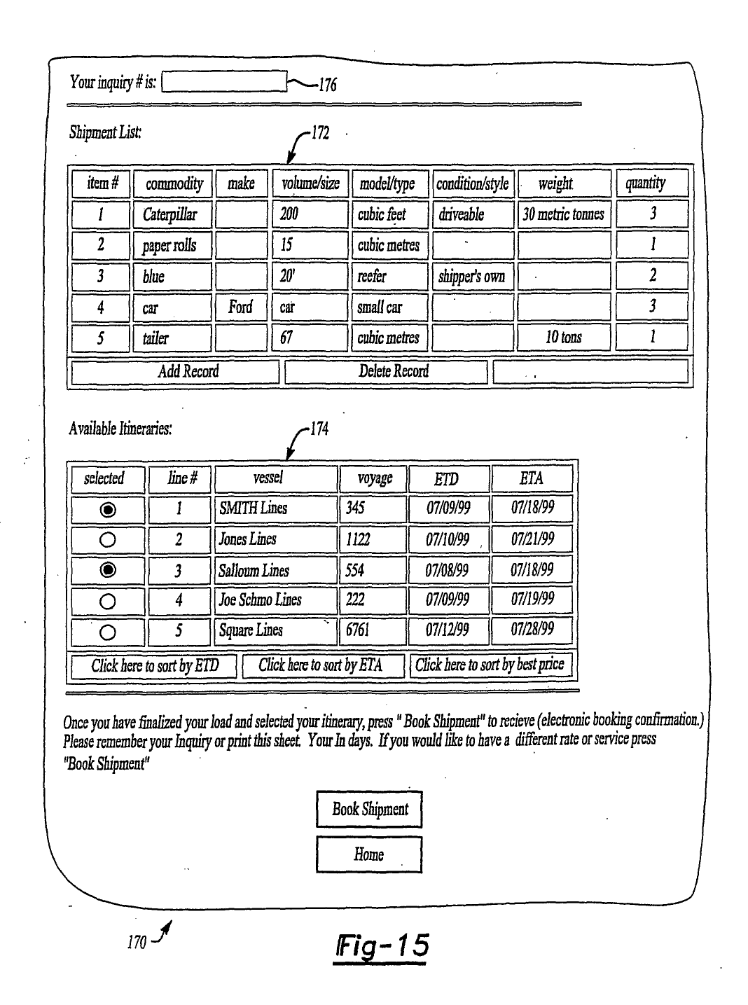

When the containers option 134 is selected, an example display page 160 illustrated in FIG. 14 is generated by the host computer system 20. The user 40 is prompted to enter vehicular information in box 165. The user 40 can be assisted with illustrations by clicking on window 166.

After the ports of loading and discharge and the type of cargo information have been entered, the host computer system 20 can generate an example display page 170 illustrated in FIG. 15. A shipment list 172 and available itineraries 174 are transmitted to the user 40. An inquiry number 176 can be generated and transmitted. The inquiry number 176 permits the user 40 to return to the host computer system 20 within a specified period and receive updates concerning the shipping options, prices, and the like.

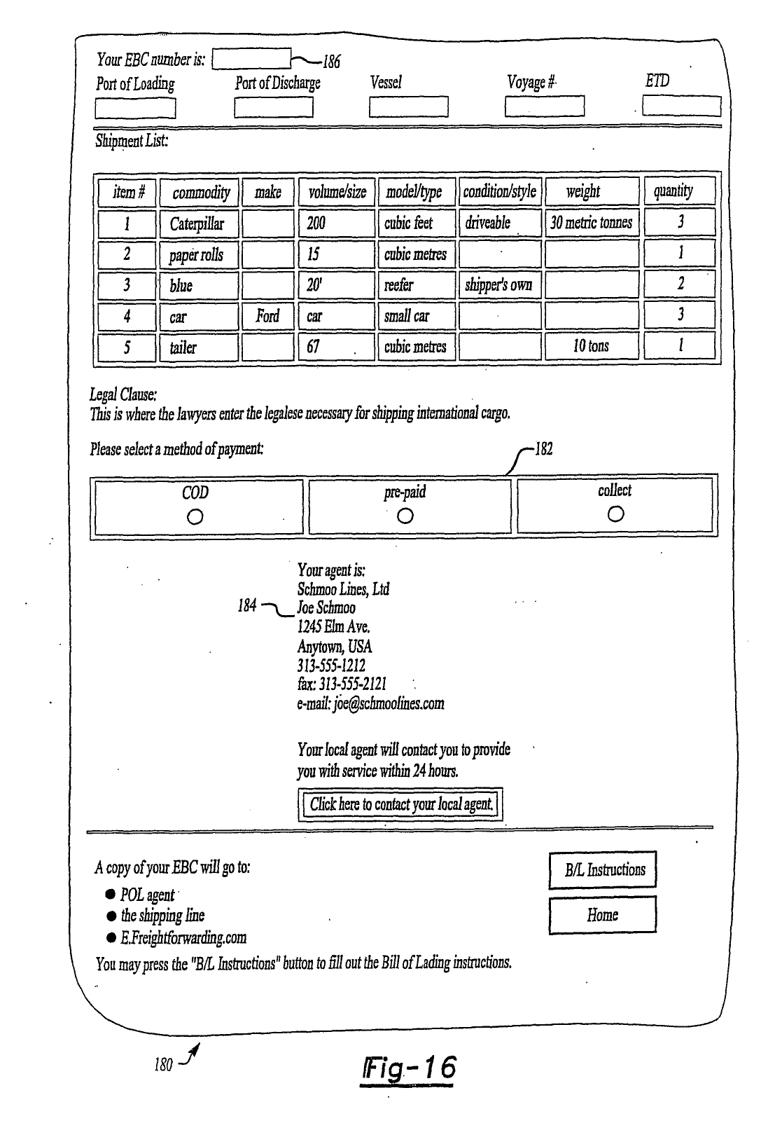

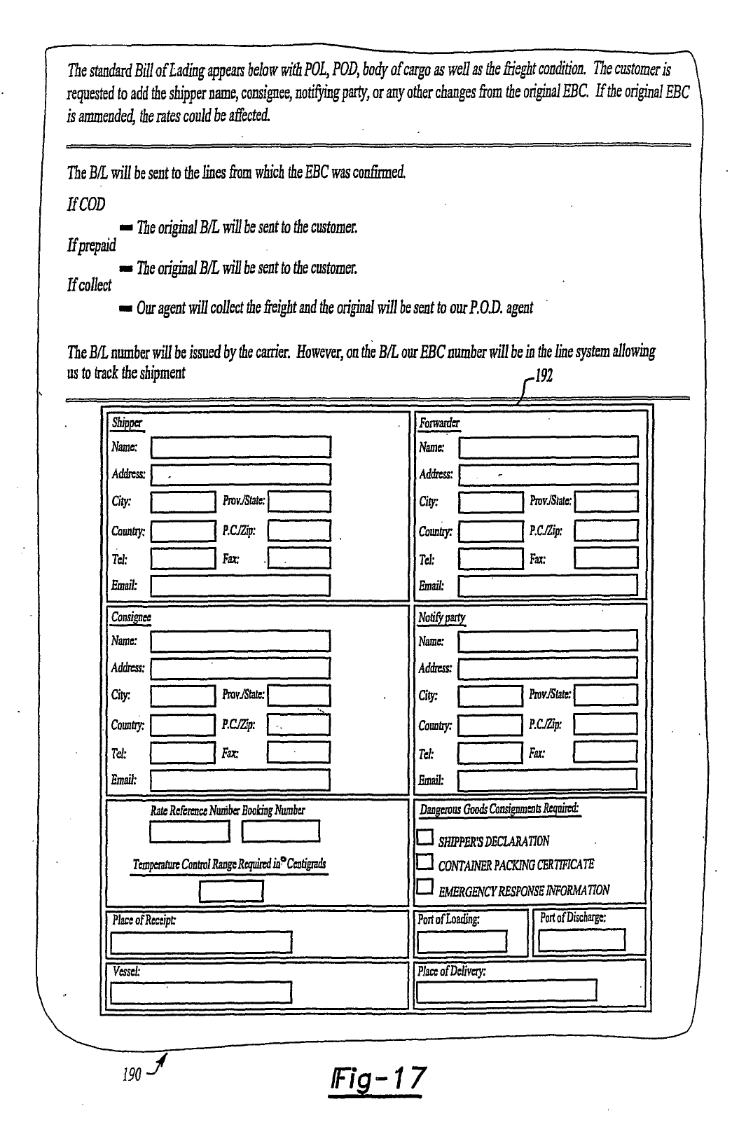

The host computer system 20 can also assist the user 40 with payment options 182 as illustrated in example display page 180 shown in FIG. 16. Other information such as agent information 184 can be transmitted to the user 40. The host computer system 20 can generate an electronic booking confirmation (EBC) 186. The EBC 186 can be used to track a shipment and determine other factors related to a shipment, such as bill of lading instructions.

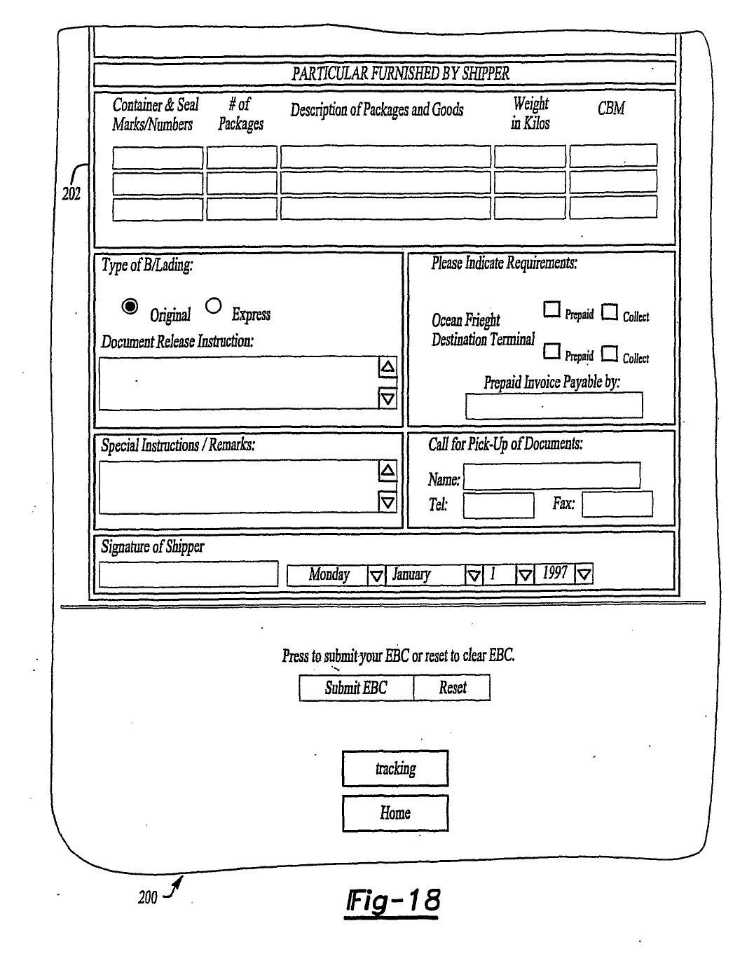

An example display page is indicated generally at 190 in FIG. 17. Bill of lading information in box 192 can be generated by the host computer system 20 and transmitted to the user 40. Additional information in box 202 of example display page 200 of FIG. 18 can be generated by the host computer system 20.

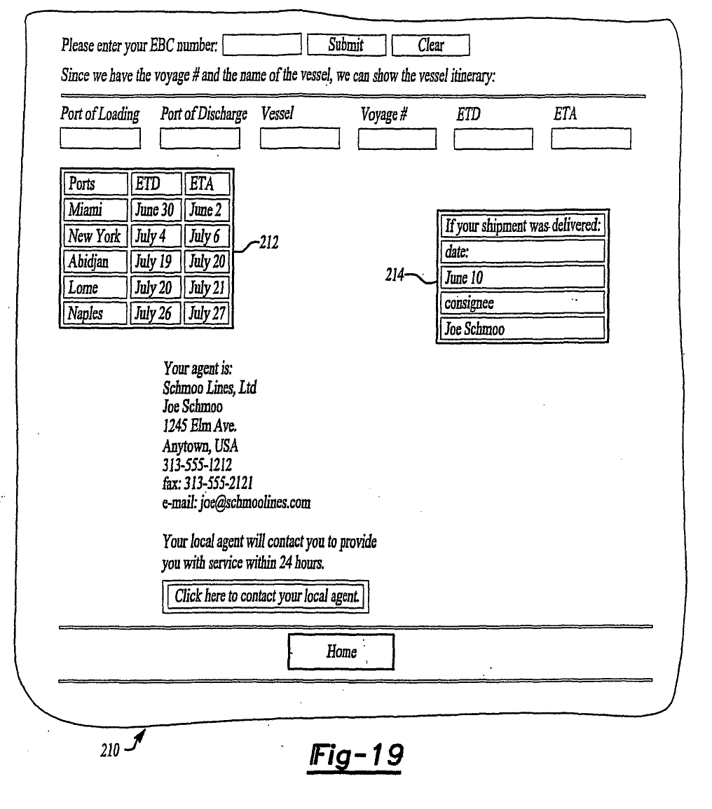

Additional information such as a vessel itinerary 212 and delivery information 214 of example display page 210 of FIG. 19 can be generated by the host computer system 20.

A user 40 can access the host computer system 20 to select options for the transportation of cargo, freight, materials, and goods. The system 20 is an interactive system that provides flexibility and updates to the user 40. For example, a user 40 can select a certain cargo transportation carrier, a certain vessel, a certain itinerary, first vessel to available, first vessel to arrive at the port of discharge, price, etc. These selections are available in an efficient manner via an internet connection.

In accordance with the provisions of the patent statutes, the principle and mode of operation of this invention has been explained and illustrated in its preferred embodiment. However, it must be understood that this invention may be practiced otherwise than as specifically explained and illustrated without departing from its spirit or scope. For example, various display pages have been presented that permit a user 40 to enter information into the host computer system 20. Various display pages have been presented that can be generated by the host computer system 20. Information related to transporting cargo other that the specific examples listed above are within the scope of this system. Additional or different inputs can be received into the host computer system 20. Additional or different outputs can be generated by the host computer system 20 and transmitted to a user 40.

The supply chain management manages the value stream from the raw material to the dealer/customer. In every phase of the value stream, logistics plays an important role in the assembling of a vehicle. One of the most important factors in the value stream is increasing the reliability and dependability of the preset supply chain management system adopted by the OEM. A delay in the delivery of a part is not always caused by the carrier moving the cargo from Point A to Point B within the value stream, but could be caused by a delay in the delivery of the cargo to the ramp/port of loading by a tiered supplier. Likewise, the delay caused by the tiered supplier can also be due to the reliability and dependability of their adopted value stream. Due to that delay, the originally-contracted, frequent service offered by a particular carrier could be missed and in this case we would have 2 delays in the delivery of that particular part/vehicle:

(Manufacturer delivery delay+the missed carrier service=major delay)

The Automobile Manufacturing Industry has spent billions of dollars to maximize IT performance in business-to-business and business-to-consumer environments to be ready for the challenge of the new millennium. However, the shipping industry has failed to follow suit.

As an example, an extremely important element in the automotive manufacturer's agenda is to optimize supply chain management, thereby minimizing order to delivery time from an average of 17 days to 5-7 days. Nonetheless vehicles are currently sitting at the port of loading for an average of 5 to 6 days. Offering more frequent service cannot be the solution, because this would result in higher operation costs per shipping line. Moreover, in order to offer a more frequent service, a steady cargo volume would be required and that cannot be guaranteed by the shipper. Offering smaller ships and increasing the frequency of service cannot be the solution either, because this would result in higher operation costs per line. Consequently, the shipper would again be paying higher prices. This would hinder the original overall policy of the OEM. Neither can faster ships be the solution, because this could result in cargo damage.

The solution is Carriersnet by providing a one system to multiple carriers to one system arrangement between the port of loading and the port of discharge.

Carriersnet will improve the IT performance of the shipping industry. Carriersnet embodies all the necessary mechanisms to target and improve the IT performance of the shipping industry in the business-to-business and business-to-consumer environment.

Carriersnet will provide the essentials to the shipper in a fashion that is easy to understand and that is tailored to the needs of the shipper. The carrier selection will be managed in the most efficient manner imaginable. The shipper will simply specify the port of loading and the port of discharge. Carriersnet will then provide a list of all possible routes and carriers which can be sorted by the shipper by estimated time of Departure, estimated time of Arrival, Price and Performance, all with the click of a button. Thus, the important elements of the shipping process—Departure, Arrival, Price and Performance (DAPP)—will be provided to the shipper in the simplest fashion possible. Carriersnet will support Supply Chain Management efforts by reinforcing the links between tiered suppliers in the automotive supply chain and OEM.

For example, each year, the auto manufacturers forecast their anticipated shipping volumes from Port A to Port B. Carriers are then solicited, and the automakers select a carrier based on which one is providing the best price, service, and performance combination. The selected carrier will then provide the year's shipping service to the automaker. Once this relationship is established, the automaker, by the inherent nature of the shipping industry, is bound to utilize only that single source for the whole duration of the contract. Utilizing another source would involve changing procedures.

When the automaker must move inventories rapidly, rather than having to wait for a ship of his originally selected, lower-priced carrier, he might be willing to pay a slightly higher price for another carrier in order to ship immediately, reduce inventory management costs, and improve order-to-delivery time.

By allowing the automaker to qualify several sources, Carriersnet will allow the automaker to establish an agreed-to shipping rate with as many carriers as the automaker wishes. Then, as the needs of the assembly plant change based on the dynamics of a manufacturing environment, the automaker can select the carrier which best fits the particular immediate shipment's needs based on the DAPP criteria—Departure, Arrival, Price, Performance. Therefore, Carriersnet will be able to provide logistical flexibility. The Shipping logistics managed in this fashion via the use of Carriersnet will reinforce supply chain management between dealers and OEMs.

Between Dealer and OEM, Carriersnet will provide the direct communications link, facilitating the shipment and tracking of the vehicle delivery to the dealer. After receiving the Advanced Shipment Notice from OEM, the dealer will send an Advanced shipment confirmation together with the DAPP shipment criteria based on his inventory level. The same methodology can also be tailored to the specific need using the DAPP criteria between the Supplier and the Assembly Plant. These services will again also be as far away as a click of a button and delivered at the speed of the world-wide web.

In addition to providing all the available shipping routes and methodologies to the consumer and customizing this information based on the DAPP criteria, Carriersnet will provide additional functionality to the consumer. Furthermore, once the OEM has selected a particular carrier and route, they will be able to track their shipment in a real time fashion. By providing these services, Carriersnet will enhance supply chain management for global business. Carriersnet can increase reliability and dependability of delivery whenever a supplier fails to deliver parts on time. Carriersnet will greatly enhance inventory management capabilities thus playing an important role on inventory costs, knowing that the inventory costs are calculated based on:

(Weekly usage+transit time+safety stock)

Carriersnet will have an impact on improving average transit time, and the reliability of Carriersnet can play an important role in the reduction of the safety stock by providing a safety net to the logistics in the value stream.

Historically, corporations have invested significantly in information technology (IT) to improve their performance within their procurement, manufacturing, and distribution operations. Logistics service providers (LSF) have invested separately in their own proprietary technology systems. However, coordination and integration between corporations and LSP's has been inconsistent from enterprise to enterprise.

Most existing logistics solutions were designed to accommodate specific requirements of select organizations. While these proprietary systems perform well within their scope, they were never intended to simultaneously manage the end-to-end flow of global shipments for a wide variety of LSP and companies. Axiolog, through the Global Horizontal E-Logistics System (GBLS), accommodates the needs of every entity involved, from the point of origin to the final receiver. This comprehensive approach effectively leverages current technology investments by employing open standards and enabling new capabilities from legacy and proprietary systems. Axiolog meets the present and future challenges faced by corporation.

A. delivers benefits and savings to trading partners and logistics providers as incentives to integrate into the GHLS through the use of:

a simple, standardized integration strategy allowing participants to participate through an internet portal application or through an electronic data interface that allows them to continue using their existing business applications and processes;

a robust, common logistic information backbone which allows the ability to easily exchange information, status, and communications to all participants supporting the different activities related to the planning, scheduling, moving, and delivering of cargo;

a central provider of global security regulations and requirements that can verify the accuracy and completeness, ensure the proper formatting, and provide automated submittal of security information to all appropriate authorities;

an application that provides unique business model that can bring true commercial efficiencies and cost savings to an enterprise (please review “Benefits through Axiolog”);

B. standardizes and simplifies the shipment process with minimum data requirements, through the use of Universal Data Elements (UTDE) which are defined based upon the standard level of information required to define the logistics process. The information requirements have been analyzed to ensure the robustness of content while minimizing the entry and processes required to identify, collect, and capture it;

C. transforms the contracted activity obligations of your trading partners and LSP's into a coordinated electronic logistics activity matrix by developed a database structure that captures, maintains, and analyses Corporate Shipper contracts. This activity matrix provides the ability to define contracts between a Shipper and their trading partners for movement, performance, and rate obligations. This function also provides the ability to identify, monitor, track and evaluate contract vs. forecast vs. actual service obligations of trading partners and LSP's between participants;

D. provides robust electronic shelf-to-shelf logistics lane management tool sets, to quickly plan and coordinate the activities of all enterprises involved in the shipment flow;

Axiolog provides the ability to establish unique shelf-to-shelf lane definitions with each handling activity being defined to a specific movement participant; including defined timings, contacts, and obligations;

a template based building tool allows a user the ability to easily define the activities defined in a movement and assists in the ability to select a participant to fulfill the role;

E. integrates inventory levels with Just-in-Time (JIT) logistics processes. Through Axiolog's integrated communications backbone, a shipper has the ability to integrate its planning and scheduling of goods through Axiolog's base planning and scheduling functionality;

F. collects and coordinates the data necessary to meet national and international cargo security initiative mandates through a central repository of requirements. This repository allows Axiolog the ability to ensure that information being entered meets security requirements and mandates as it is entered and to perform the formatting and automated submission of forms and required documentation;

G. monitors and tracks the real time status of shipments globally through the use of Global Positioning Satellite technology. This allows Axiolog to provide customers up-to-date tracking information that can highlight defined routines, deviations from route, direction, speed, and estimated time to arrival. This information can also be used by Custom and border authorities to monitor cargo movements, conveyance volumes, and to define potential security risks through information collected to meet national and international cargo security initiatives and mandates;

H. provides early alerts for incident or anomalies and provides access to the information and tools necessary for a proper resolution of potential problems. Capturing information throughout the entire logistics process, Axiolog has the ability to:

analyze data from the early planning stages of cargo's movement. This allows it to define risks in the entry (identifying entry errors), the collection (evaluation of missing information), assembly (miss-matched or conflicting data), and scheduling (capacities of conveyance, participants, and ports) information;

identify and provide alternatives for issues that are identified during the movement of cargo through real-time tracking and monitoring of conveyance, ports, weather, or activity participants;

I. monitors and evaluates contract vs. forecast vs. actual service obligations of trading partners and LSP's;

J. maximizes forecast and control over the corporate global logistics bill by capturing the contract obligations of each activity participant within a defined movement lane. Through the monitoring and tracking of the conveyance, Axiolog has the ability to know when an activities job is complete, the specifics or the activity, and when and how a provider is eligible of compensation. Thus, the shipper has the ability to better forecast a participant's performance and costs and ensure better control over the logistics bill, —especially if movement or performance issues arise;

K. provides historical data to assist in future planning and audit reviews by capturing, maintaining, and making available the information captured on shelf-to-shelf movements coordinated through Axiolog. This information will be available, on-line, for a period of time before it is archived for future use;

L. integrates with financial and insurance partners to provide value added services through Axiolog's robust communication backbone. This allows users of the system to easily communicate and transfer information with financial and insurance partners. Financial and insurance partners have the ability to have greater exposure to participants and provide services.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1-20. (canceled)

21. A computerized system for selecting a cargo carrier and arranging transportation for cargo, the system comprising:
a host computer system having access to data of each of a plurality of cargo carriers, the data representing cargo transportation options available from each of the cargo carriers;
internet access means connecting the host computer system to a user;
means in the host computer system for prompting the user for and receiving from the user information concerning cargo to be transported and transportation preferences;
means in the host computer system for comparing the user information with the available cargo transportation options and sending to the user at least one of the available cargo transportation options best matching the user information; and
means in the host computer for supplying security information to a user and to provide automated submittal of security information to appropriate authorities.

22. The system defined in claim 21 including the host computer checking the accuracy and completeness of the security information prior to submission to the appropriate authorities.

23. A system for arranging for cargo transportation by a selected cargo carrier comprising the steps of:
providing a host computer system;
linking cargo carrier computer systems of a plurality of marine, air, and land cargo carriers to the host computer system, each cargo carrier computer system having data representing cargo transportation options available from the associated cargo carrier including departure, arrival and space availability information;
accessing the host computer system through an internet connection;
transmitting information from a user to the host computer system about cargo that is to be transported and transportation preferences;
comparing in the host computer system the user information and the available cargo transportation options and sending to the user at least one of the available cargo transportation options best matching the user information;
having the user select at least one cargo carrier and at least one cargo transportation option and conveying that selection to the host computer; and
preparing and transmitting required security information from the host computer to appropriate authorities.

24. The system defined in claim 23 including the host computer checking the accuracy and completeness of the security information prior to submission to the appropriate authorities.

25. An on-line interactive system for selecting a cargo carrier and booking transportation of cargo comprising the steps of:
providing a host computer system;
linking cargo carrier computer systems of a plurality of marine, air, and land cargo carriers to the host computer system, each cargo carrier computer system having data representing cargo transportation options available from the associated cargo carrier;
accessing the host computer system through an internet connection;
transmitting query information over the internet connection from the host computer system to a user requesting information about cargo that is to be transported, the query information being based upon the available cargo transportation options;
transmitting user information over the internet connection from the user to the host computer system responding to the query information, the user information including selection of at least one transportation preference based upon the cargo transportation options available; and
transmitting from the host computer to appropriate authorities security information based on the selection of the at least one transportation preference.

26. The system defined in claim 25 including the host computer checking the accuracy and completeness of the security information prior to submission to the appropriate authorities.
